(19) United States
(12) Patent Application Publication
(10) Pub. No.: US 2019/0037799 A1
(43) Pub. Date: Feb. 7, 2019

(54) SELF-CONTAINED VEHICLE CAGE AND PET STAIRS APPARATUS WITH FOLDING PERIPHERAL FENCE

(71) Applicant: Alan Murray, Brookings, OR (US)

(72) Inventor: Alan Murray, Brookings, OR (US)

(21) Appl. No.: 16/158,830

(22) Filed: Oct. 12, 2018

Related U.S. Application Data
(63) Continuation-in-part of application No. 15/433,733, filed on Feb. 15, 2017, now Pat. No. 10,098,314.

(51) Int. Cl. A01K 1/02; A01K 1/00; B60R 3/02; B60P 3/04

(52) U.S. Cl. CPC A01K 1/0272; A01K 1/0035; B60P 3/04; B60R 3/02; A01K 1/0245

(57) ABSTRACT

Combination pet cage and stairs apparatus including rigid fence panels pivotally mounted about the periphery of a horizontal frame formed with an upwardly facing floor, the panels constructed for rotation between lowered positions on the frame and erect positions supported about the periphery of the frame. In one embodiment the horizontal frame includes a tunnel from which a telescopical ladder device is extended of receiving pets to be introduced onto the floor to be contained by the erected fence panels.

### CROSS-REFERENCES TO RELATED APPLICATIONS

This application is a continuation-in-part of U.S. application Ser. No. 15/433,733 filed Feb. 15, 2017 and incorporated by reference in its entirety.

### FIELD OF THE INVENTION

The invention relates to pet cages for housing pets while traveling in vehicles.

### BACKGROUND OF THE INVENTION

In the United States alone there are some 46 million households with pets, and of those, 65% are larger breed dogs. The overall market for pets is $50 billion per year, and about 50% of that is dog owners. Pet owners and pets alike prefer each other's companionship, even when traveling by vehicle.

Pets, particularly dogs, are always ready for a ride in an SUV, crossover or other vehicle having some degree of interior space.

The rear door of a SUV or a crossover typically opens to an elevated floor, thus requiring the pet to leap up or be lifter up onto the floor of the rear bay. This serves well for younger dogs but as they grow older and joints deteriorate, the leap is highly challenging or totally impossible. Furthermore, in this arrangement the pet occupies practically the entire length and width of the bay, thus leaving no space available for other utility, such as storage of groceries, sporting goods, hunting equipment and dog paraphernalia.

Even then, the dog requires restraint, thus leading to the owners utilizing wire or rope barriers or the like partitioning the front and rear of the vehicle. This still leaves the rear of the vehicle totally dedicated to the pet, without space for other cargo.

The problem with loading dogs and particularly larger dogs into the vehicle often involves the purchase of a generic ladder or the like, which might be foldable or collapsible to be stored in the back seat and deployed at the loading spot. To make the load, the driver removes the ladder from the back seat and unfolds the sections to lean the top end against the bumper or rear of the vehicle to hopefully allow the dog to climb up the ladder without falling to the right or left or destabilizing the ladder. The problem is exacerbated in foul weather when the ladder ramp may be exposed to the elements and the bottom end submerged in mud or water, often resulting in unequal loading and risk and fright to the animal as he or she seeks to climb the ramp.

It has long been known that there is a critical need for lift and ramp devices for older dogs. There are several reasons why this need has grown over the years.

First, older pets are not viewed as expendable and owners of those with mobility limitations often seek various devices to maximize the quality and length of life for both the animal and owner such as detachable wheels that may be strapped to the animal to provide mechanical means of independent movement or lightweight portable lift devices such as hoists and the like. One significant challenge is that animals often tend to resist, particularly in inclement conditions, walking up a ramp where their paws might slip or be unstable. They may have a tendency to pull away from the owner or leave the ramp partway up, thus leading to injury and challenges for reorganizing the animal and getting them back on board.

These issues have been addressed in the past including the proposal of a deployable ramp with opaque sidewalls to confine the animal ascending the ramp to avoid a sense of elevation which might disturb some animals. A device of this type is shown in U.S. Pat. No. 8,899,188 to Douglas. Such devices, while helpful for distracting animals from fear of height, are cumbersome and inconvenient to use, requiring some degree of skill and strength to store and deploy.

Other efforts have led to the proposal that a ramp that can be hinged to the rear of a vehicle and articulated so that it can be folded out for access by the animal. A device of this type is shown in U.S. Pat. No. 6,715,177 to Lagergren-Julander. Such devices again suffer the shortcoming that they must be folded up and stored in the back seat or back bay of the vehicle and must be pulled out and unfolded each time of use to be somehow releasably attached to the vehicle itself.

It is also recognized that there can be benefits to containing the pet within the confines of an enclosure to be installed in a vehicle. That is, it has been proposed to provide a collapsible framework with mesh or the like to thus provide a separate housing with the vehicle. A device of this type is shown to U.S. Pat. No. 4,803,951 to Davis. Such devices, while providing some containment for the animal, are inconvenient to use and do not employ any arrangements for other components such as ramps, stairways or storage drawers.

### SUMMARY OF THE INVENTION

The present invention includes a horizontal frame to occupy a portion of the width of the bay of an SUV or the like to form a floor and leaving the remainder of the bay available functions other than transporting a pet. Rigid fence panels are pivotally supported at their respective lower extremities from the peripheries of the horizontal frame and are constructed to be shifted between respective vertical erected positions to lowered positions folded over the floor of the frame.

The features and advantages of the invention will be more readily understood from the following detailed description which should be read in conjunction with the accompanying drawings.

### BRIEF DESCRIPTION OF THE DRAWINGS

FIG. 1 is a perspective view showing the rear bay of a vehicle receiving a pet cage and stairway device of the present invention;

FIG. 2 is a perspective view of the right hand side of the apparatus shown in FIG. 1;

FIG. 3 is a rear perspective view of the vehicle shown in FIG. 1, in reduced scale, with the stairway deployed;

FIG. 4 is a rear perspective view of the vehicle shown in FIG. 1 with the stairway deployed;

FIG. 5 is a rear perspective view of the vehicle shown in FIG. 1 depicting the stairway apparatus;

FIG. 6 is a detail view similar to FIG. 5, but showing the stairway more deployed;

FIG. 7 is a rear perspective view of the pet cage and stairway apparatus shown in FIG. 1;

FIG. 8 is a rear perspective view similar to FIG. 7 but showing a cushion on the bottom frame of the apparatus of the present invention;

FIG. 9 is a rear perspective view similar to FIG. 8 but showing contour cushions about the periphery of the bottom frame;

FIG. 10 is a perspective view, in enlarged scale, of a post incorporated in a fence included in the apparatus shown in FIG. 1;

FIG. 11 is a partial perspective view of a second embodiment of my pet cage and stairway device of the present invention;

FIG. 12 is a partial perspective view, in enlarged scale, of the pet cage and stairway apparatus shown in FIG. 11;

FIG. 12a is a detail perspective view, in enlarged scale, taken from the circle 12a in FIG. 12;

FIG. 13 is a partial perspective view, in reduced scale, of the pet cage and stairway device shown in FIG. 12;

FIG. 13a is a detail view, in enlarged scale, taken from the circle 13a in FIG. 13;

FIG. 14 is a front perspective view, in enlarged scale, of the pet cage and stairway device shown in FIG. 12;

FIG. 14a is a detail view, in enlarged scale, taken from the circle 14a in FIG. 14;

FIG. 15 is a perspective view of the pet cage and stairway device shown in FIG. 14 with the stairway device partially deployed; and

FIG. 16 is a partial perspective view of the pet cage and stairway device shown in FIG. 15.

### DETAILED DESCRIPTION OF THE PREFERRED EMBODIMENTS

Referring now in more detail to the exemplary drawings for purposes of illustrating embodiments of the invention, wherein like reference numerals designate corresponding or like elements among the several views,

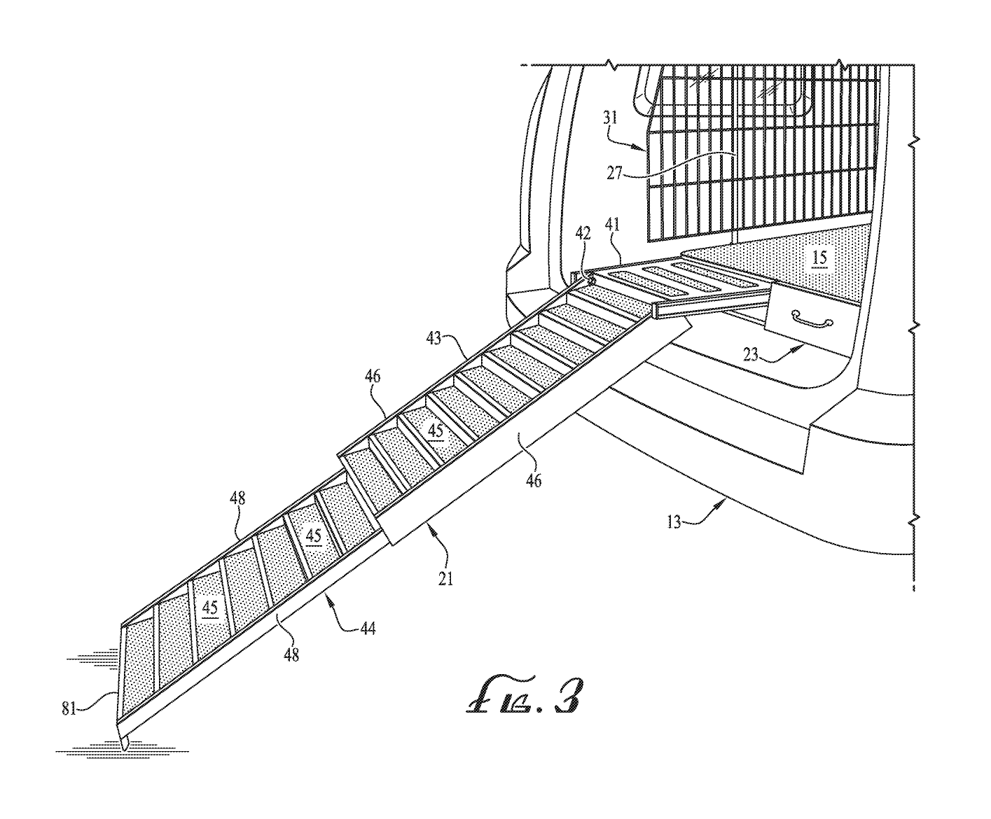

In one aspect, the present invention is intended for use in the rear bay of a vehicle, such as a crossover or SUV 13. My device includes a bottom horizontal frame, including bottom and top walls 14 and 15, respectively, spaced apart to form therebetween rearwardly opening first and second tunnels 17 and 19 for, and in this embodiment, receipt of respective rearwardly slidable ramp or stairway device 21 and drawer 23. For the purpose of illustration, I show my stairway device 21 as being telescopically extendable from the tunnel and including a rearwardly slidable, cantilevered, top platform 41, to which a top stairway section 43 is pivotally connected by transverse bolts 42. An extendable lower stairway section 44 is telescopically carried by the section 43. Preferably, the stairway sections 43 and 44 include steps spaced therealong and formed with respective surfaces 45 disposed in horizontal planes when the stairway device is deployed as shown in FIG. 3. The device includes an upstanding front fence 35 and side fence 37 which act to partition from the forward seats and to divide the width of the bay into approximately one-half the overall lateral span thereof an are pivotable to respective lowered positions overlying a floor formed by the top wall 15.

Utility vehicles, such as crossovers and SUVs, have become highly popular with pet owners due to the convenience of use and space provided. These vehicles are typically formed with a planer floor and vertical outboard walls 20 and a rearwardly opening doorway, which might be on the order of five feet wide, thus leaving generous space for access from the rear. It is common practice for pet owners to thus place their pets in the rear bay, occupying the entire width thereof, thus depriving the owner of that space for storage of paraphernalia and items to be transported such as groceries, shotguns, duck decoys, and other items which cannot safely be comingled with the pet.

Thus, in one aspect of the present invention, I provide my pet cage of a width which will leave at least a portion of the bay separated from the pet as, for instance, a quarter to one-half or so of the entire width.

I construct my bottom frame with the horizontal walls 14 and 15 spaced vertically apart a distance of, say, four or five inches to thereby provide a height for my tunnels 17 and 19 adequate to receive a robust stairway device and drawer.

In the preferred embodiment, I provide a framework, including vertical spaced apart stub posts 30 supporting the wall 15, which acts as a false bottom for the pet compartment. In some embodiments, I cover the wall 15 with a covering which may be plastic, rubber or other durable covering.

As shown in FIG. 3, the top form and mounting slider tracks are so constructed that, when the fully retracted, the back end mounting the bolts 42 are disposed in the vertical plane of the vehicle back bumper to dispose the telescopically stairway sections clear of such bumper.

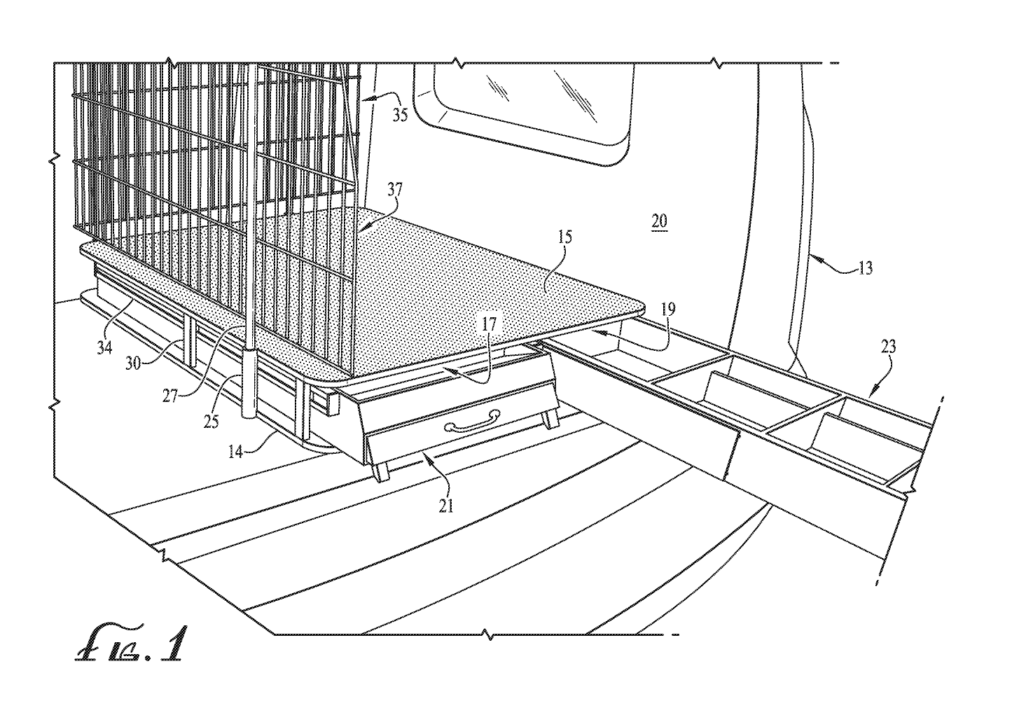

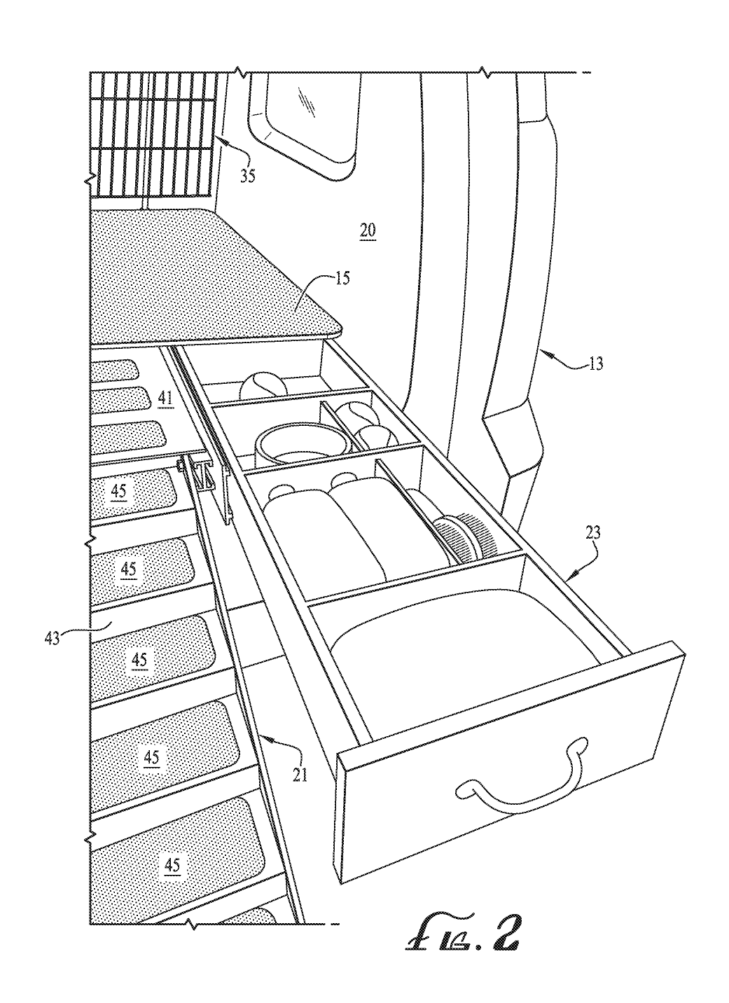

Mounted from the opposite sides of the tunnel 17 are rails defining oppositely opening horizontal tracks 34 to accommodate horizontal sliding of the platform 21 relative to the bottom frame and sliding of the upper end of stairway section 21 rearwardly relative to such platform so the platform may be drawn horizontally rearwardly to support the upper section in cantilever fashion. To this end wheels or sliders 24 (FIG. 1) may be mounted to the opposite sides of platform 41 to engage the respective tracks and, similarly sliders or wheels mounted to the opposite sides of the platform to engage the inner track.

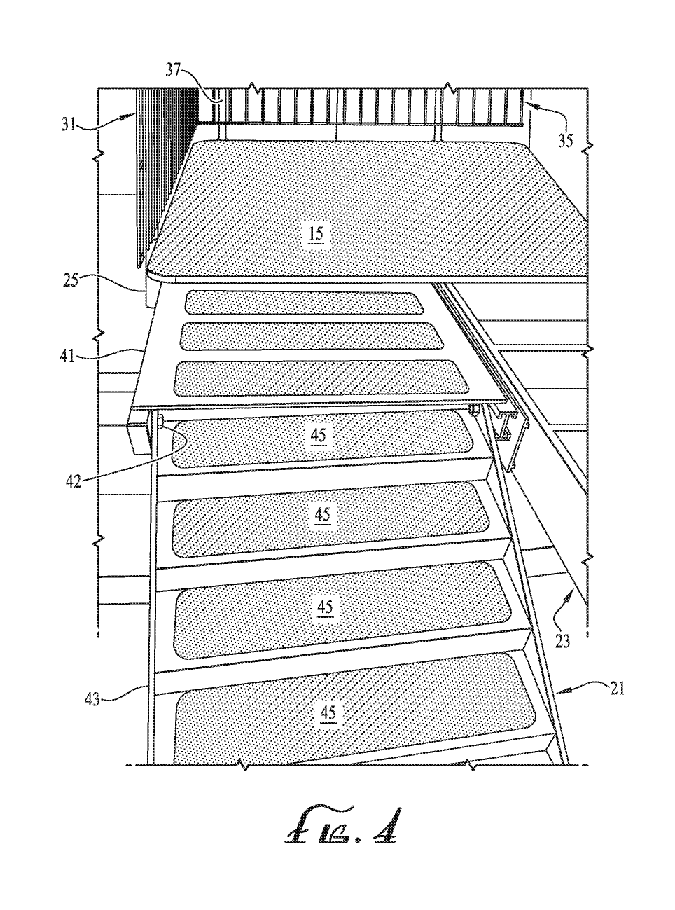

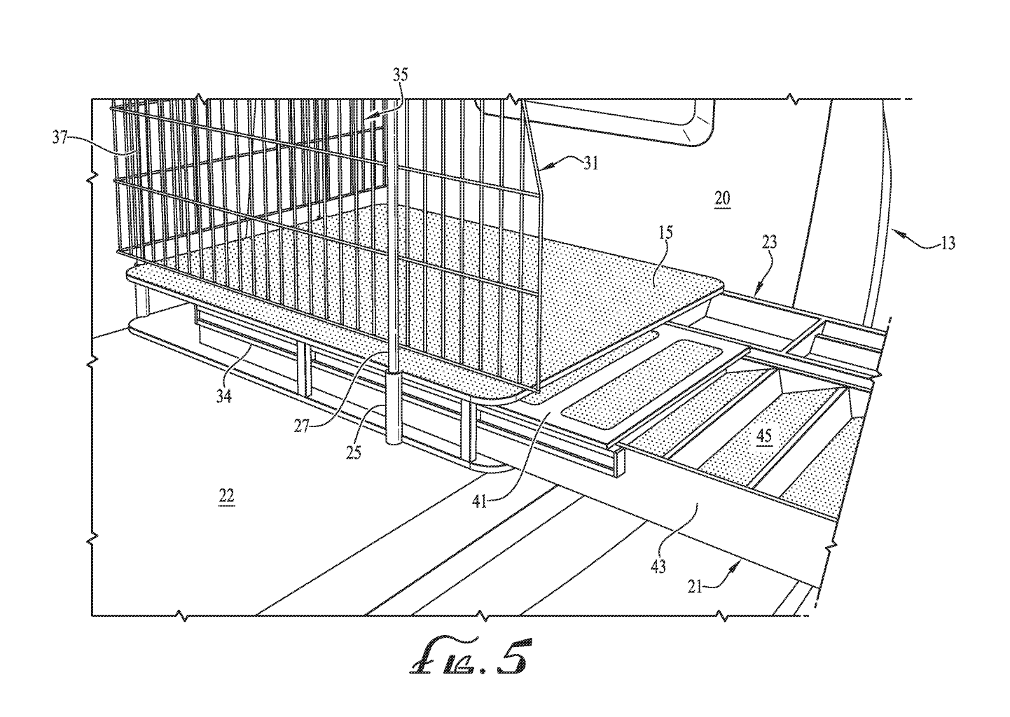

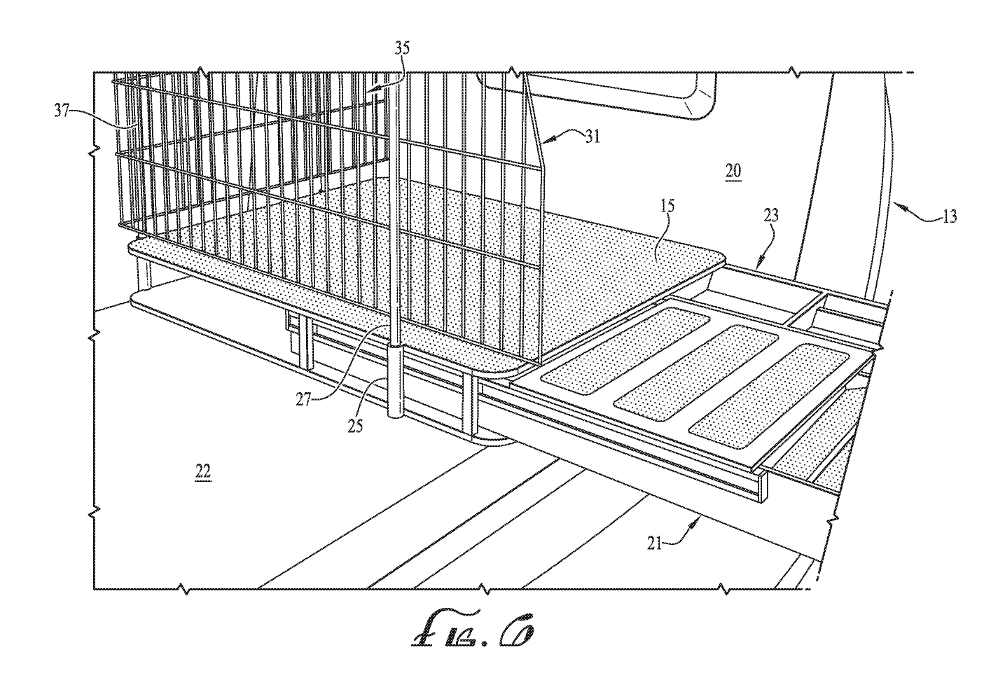

To that end the upper stairway section 43 is configured with side walls 46 which are carried on their upper extremities from tracks 20 defined by the rails 34 by means of sliders carried on bolts 42 (FIG. 4) for pivoting and sliding relative to such tracks. Formed on the interior walls are respective inwardly opening longitudinal tracks which receive the side slats 48 of the lower section 44 to accommodate sliding longitudinally to telescope the lower section into the upper section.

The front and side fences 35 and 37 are preferably constructed of heavy gauge wire or thin rods to form a gridwork to be self-supporting or supported from vertical posts 27 carried in upwardly opening cylindrical receivers 25 mounted to the sides and front end of the bottom frame.

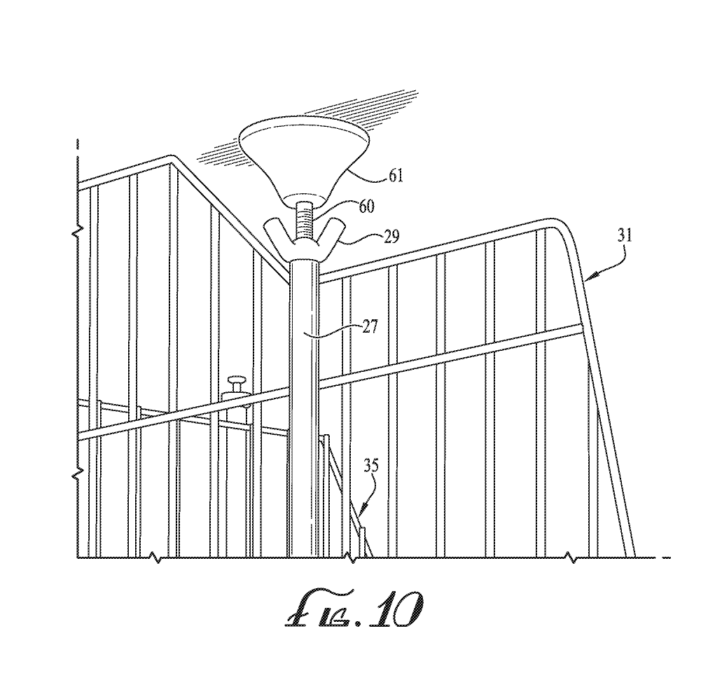

In some embodiments, I incorporate a holding device for compressing against the vehicle overhead to cooperate in holding the respective fences in place. Referring to FIG. 10, for the purposes of illustration, I show a threaded rod 60 mounting a pressure plate 61 on the upper extremity thereof and driven upwardly and downwardly within the top of the open post 27 by means of a wing nut 29 so that once the fences are in place, wing nut 29 may be rotated to drive the pressure plates against the upholstery on the roof of the vehicle.

In one preferred embodiment, I incorporate a mattress 57 configured to the exact dimensions of the false bottom 15 to cover such false bottom in its entirety. In this embodiment, I incorporate an impervious cover for covering the cushioning mattress for the pet's comfort and to receive hair, grease and debris from the pet and which can be easily removed and washed by a hose or the like.

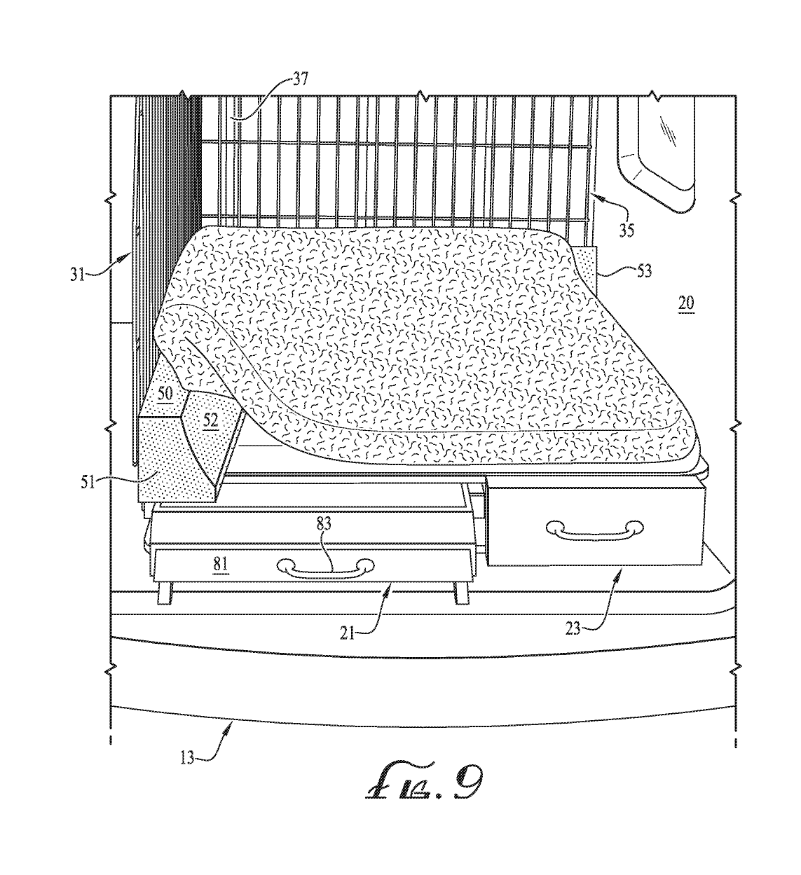

In some embodiments, I incorporate contoured cushions 51 and 53 (FIG. 9) along the respective fences 31 and 35 to fit the contour of a dog lying on the mattress covering such cushions. The cushions are formed with perpendicular bottom and back sides as well as a marginal top surface 50 and then curves downwardly and inwardly to form a concave inwardly opening nest 52.

It will be appreciated that the drawer 23 may come in numerous different configurations and incorporate various compartments for different paraphernalia. For the purpose of illustration, I show the drawer as being customized for pet toys, water, grooming tools, cushions and the like to facilitate the organization and storage thereof and provide for ready access when needed.

In operation, it will be appreciated by those skilled in the art that the device of the present invention is economical to manufacture and convenient to use. The device may be made in several different components, sold separately and acquired by the pet owner as the pet matures or habits of the pet differ over time.

Typically, the bottom frame is fabricated and sold with the tunnels 17 and 19, with or without the stairway 21 and/or drawer 23.

In any event, the apparatus itself is self-contained and can easily be installed with a minimum of skill and effort by merely loading the frame into the vehicle 13 and erecting the front and side fences 35 and 31. The fences are erected by positioning them vertically on the respective front and the inboard side of the bottom frame with the lower ends of the respective posts 27 nested against the bottom walls of the upwardly opening receivers 25 to provide vertical support. In some embodiments, which include the pressure pad 61, the adjustable wing nuts 29 may be rotated to push the pressure pads upwardly into contact with the lining of the roof to trap the posts between the bottom walls of the receivers 25 and the lining for additional security and support, something that may be preferable for larger dogs which might bump against the respective fences when the vehicle either slows or turns a right hand corner.

In those embodiments which include a stairway device 21, the upper platform 41 will be slid back into the tunnel and the middle stairway section 43 and lower section 48 raised to slide the slider supporting the pivot 42 rearwardly in the track 21 and forwardly into the tracks on the inside of the respective side walls 46 of the upper stairway section 43 to thus telescope the upper section 43 relative to the platform 41 and the lower section 44 into the upper section 43, thus creating a relatively neat and attractive closure as depicted in FIG. 9. In some embodiments, the lower end of the lower stairway section 44 includes a face plate 81 mounting a handle 83 for convenience of shifting. The lower stairway section 44 may also mount on its lower extremity a brace or foot 66 (FIG. 3) which may be pivoted downwardly when deployed to serve as a support for the lower end of such section 44 to maintain the bottom end elevated from the supporting surface.

Likewise, either upon initial purchase or as an add-on later, a drawer 23 may be acquired to fit within the associated tunnel to provide for convenient storage and easy access.

It will be appreciated that the owner may elect to purchase the contoured cushions 51 and 53 to be disposed in close fit relationship along the respective side and front of the cage defined by the fences 31 and 35, respectively. The mattress 57 may then be positioned on the upper wall 15 and folded upwardly onto the respective contoured cushions 51 and 53 as shown in FIG. 9.

When the owner elects to take the pet on an outing, he or she may open the back door of the vehicle 13 for access to the interior of the cage. For a younger and nimble pet, the pet may readily spring upwardly into the interior of the cage without the assistance of a stairway or ladder. Then, by closing the rear door, the pet will be confined to the interior of the cage and will be blocked from leaping forwardly over into the passenger seats or intruding on the inboard side of the cage, thus leaving the storage space 20 open and accessible for storage of groceries and the like during transport.

For older or larger dogs, the owner will want to have the benefit of the stairway and can easily deploy the stairway for loading and unloading of the pet. This may be achieved by, when the rear door of the vehicle is open as in FIG. 9, grasping the handle 83 and easily and effortlessly drawing the platform 41 rearwardly and drawing the upper and lower stairway sections rearwardly to telescope them apart to the deployed position shown in FIG. 3. In my preferred embodiment, the components are so balanced that this deployment may be by one finger. The foot 66 (FIG. 3) at the bottom of the section 44 will provide support from the ground and, in some instances, is formed to elevate the bottom of the stairway to maintain it raised from underlying debris or mud or the like.

With the stairway 21 so deployed, the animal will have ready access to the steps 45 to walk up the stairway sections 44 and 46 at a favorable angle with his or her paws on the horizontal surfaces 45, thus giving a sense of security and stability as the pet progresses up the sections 44 and 43 to the platform 41 to enter the cage area to rest on the upper wall 15 or cushion, as the case may be.

With the pet loaded in the cage, the stairway 21 may be easily raised and the sections 44 and 43 telescoped together and into the platform 41, driving it forwardly into its stored position for convenient and compact storage during the ride.

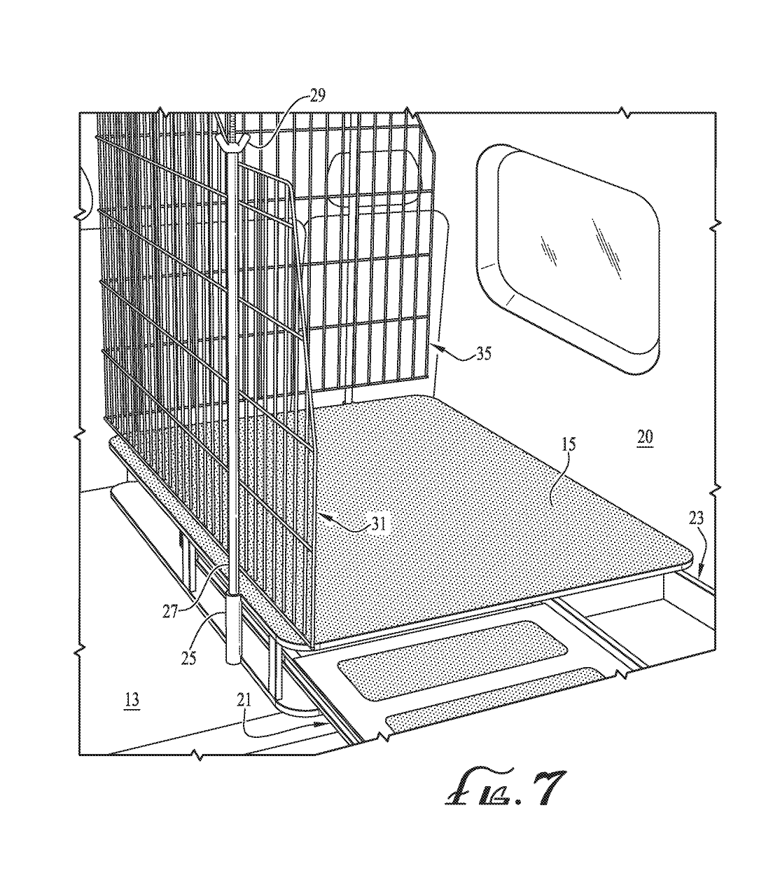

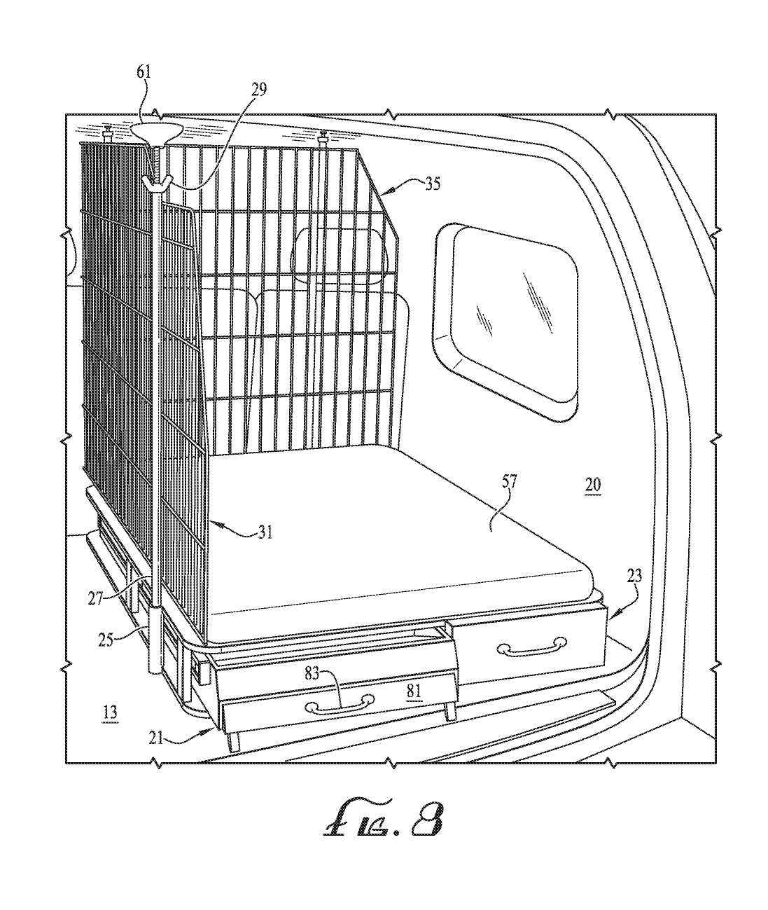

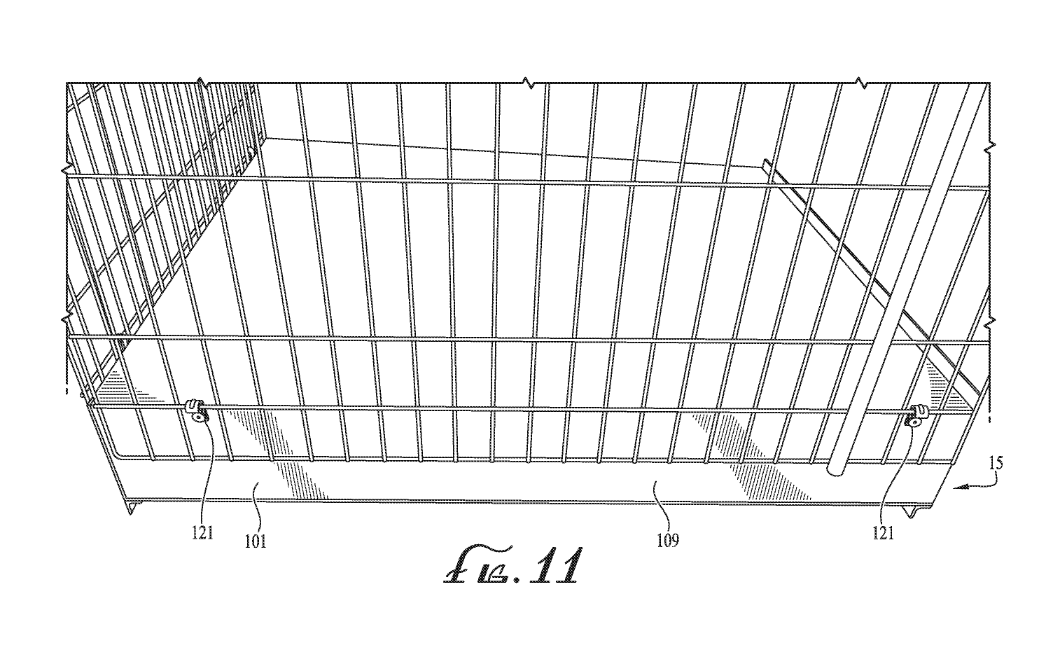

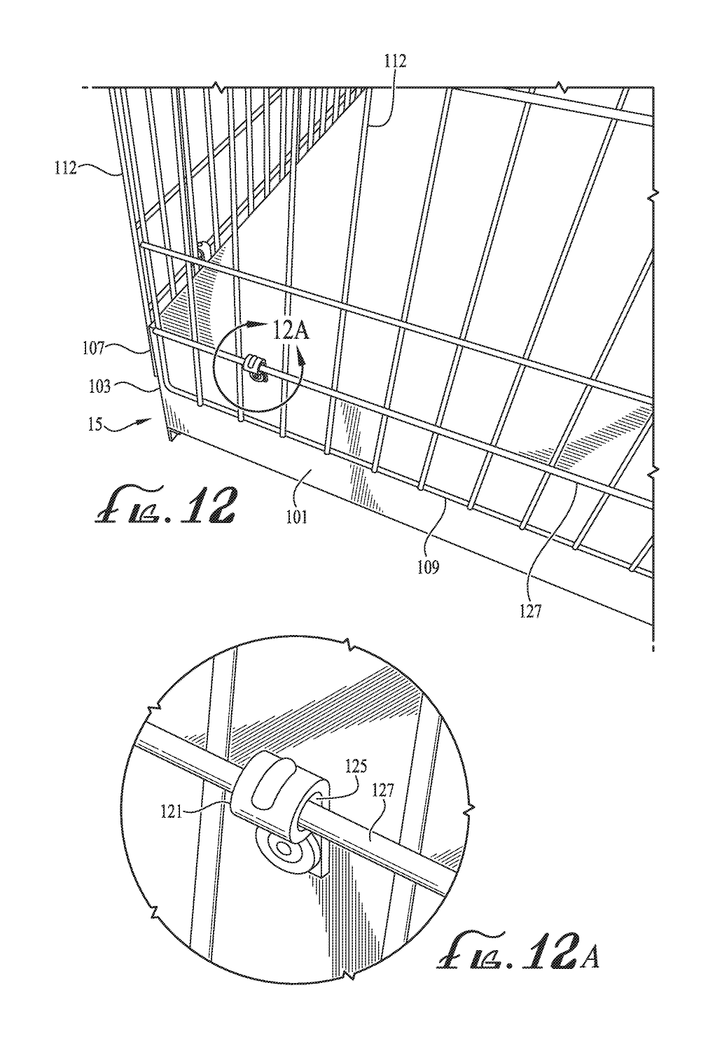

Referring to FIGS. 11 and 12, the embodiment shown is similar to that shown in FIG. 7, except that the bottom frame 15 is formed with vertical inboard and front sides 101 and 103 against which the bottom sections 107 and 109 of respective fence panels 111 and 112, abut. Knuckle fittings 121 are mounted to the respective inboard and front ends of the horizontal frame 15 and are formed with respective horizontal bores 125, which grip a respective horizontal run 127 of the respective fence panels.

As will be appreciated by those skilled in the art, the lower section, sections 107 and 109, projects downwardly, below the respective knuckle fittings 121 (FIG. 11) such that, when the fence panels are in their erect position, such lower sections abut the walls of the horizontal frame to facilitate supporting the fence panels in the vertical positions

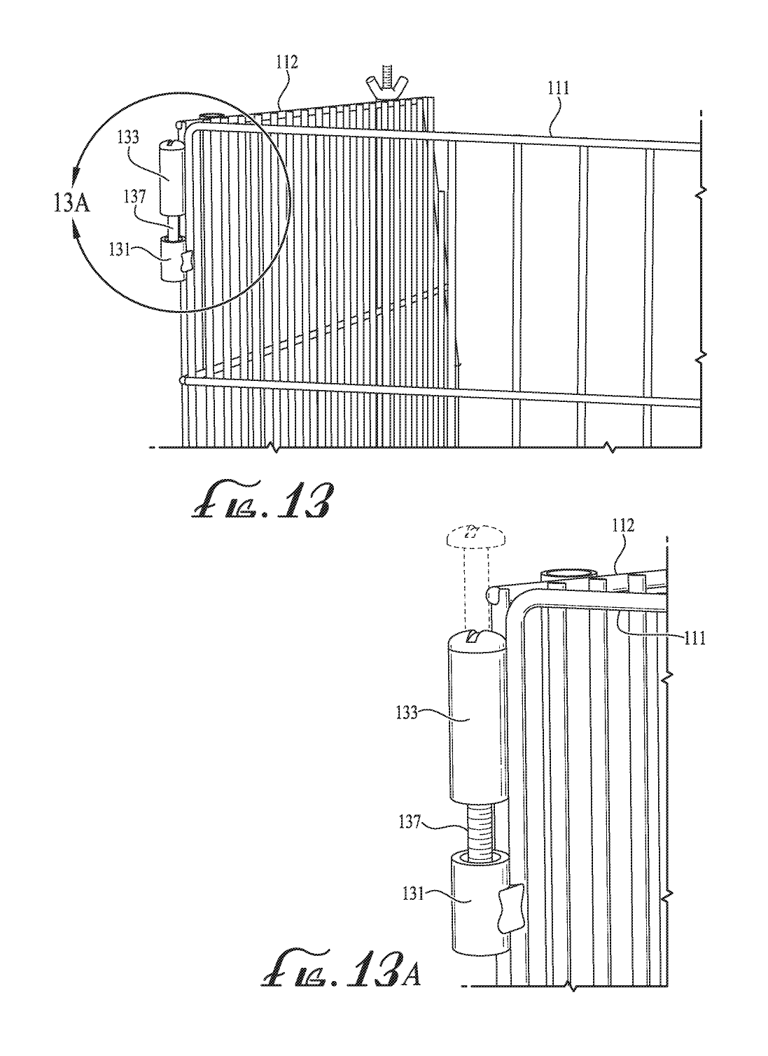

Referring to FIGS. 13 and 13a, the fence sections are each formed with a vertical run at their respective juxtaposed ends to mount respective connectors 131 and 133 configured with vertical bores such that, when the fence panels are in their erect position, the respective bores are aligned vertically with one another for receipt of respective removable bolts 137, which serves to removably connect the fence panels together.

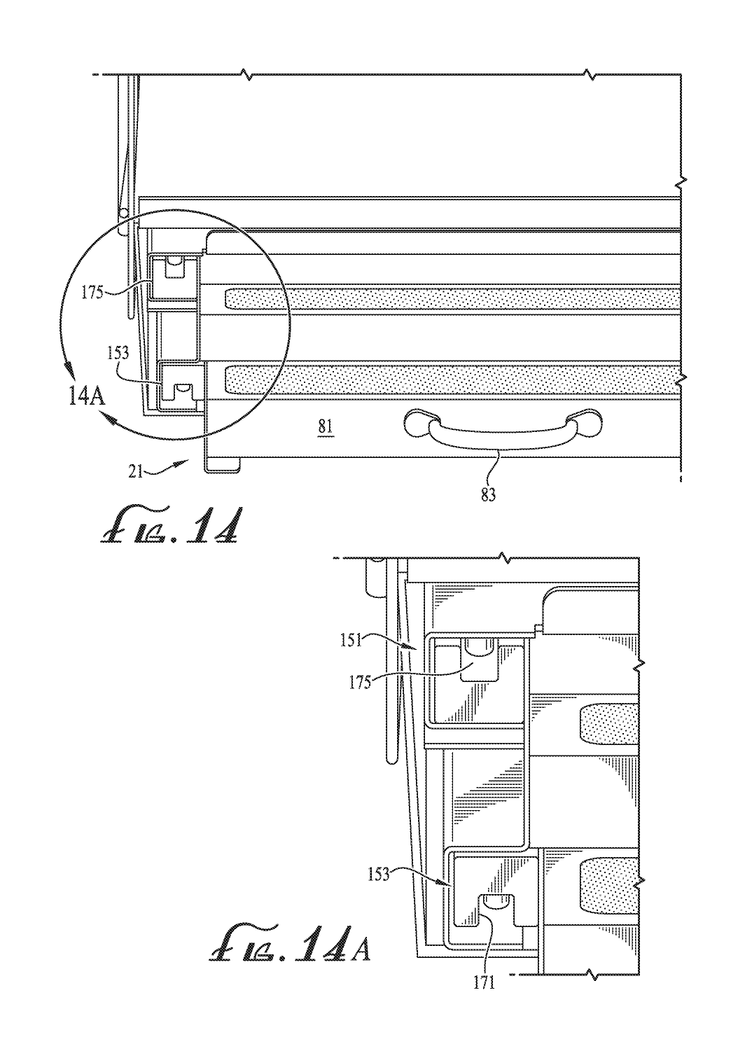

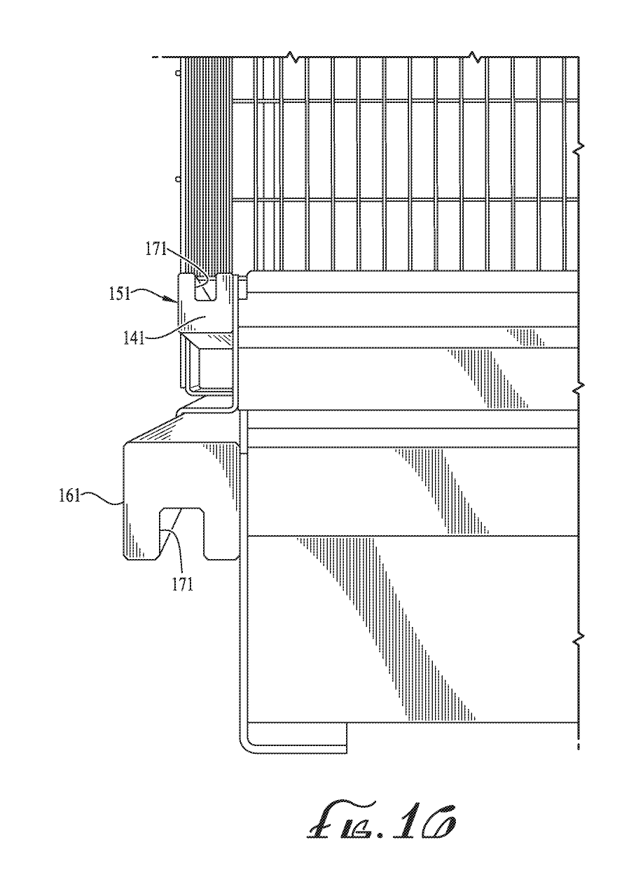

Referring to FIGS. 14-16, the stairway apparatus includes the sections 151 and 153 which are telescopically connected together and deployable from the tunnel housing 157. The sections 151 and 153 include, on their opposite sides, respective longitudinal channels 161 formed with vertically opening channel tracks 171.

The respective channels 151 and 153 are typically configured to receive in the channels 171 dogs or followers 175 of adjacent track sections, such that the track sections may be deployed conveniently for support during deployment and also while the sections are deployed, and the steps are loaded by a pet, boarding the vehicle.

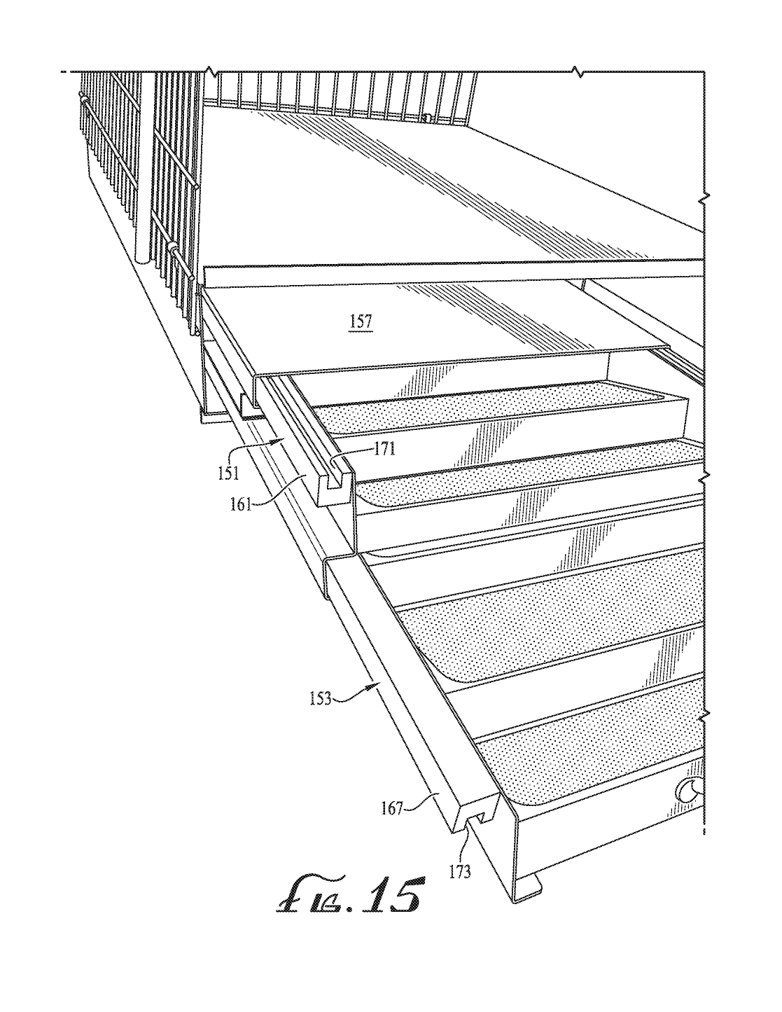

As will be appreciated from FIGS. 14, 14a and 15 the construction is such that the components may be conveniently formed by bending sheet metal into the configuration for receiving, containing the respective track sections 151 and 153 for containment and deployment, thereof.

From the foregoing, it will be appreciated that the apparatus of the present invention, in its various aspects, provides a convenient, inexpensive and effective means for containing a dog or other pet in a regulated area of a rear bay of a van or the like. The device is convenient to install and provides an organized arrangement for loading, unloading and transport of the dog. The stairway is stored in an organized and convenient fashion with minimal effort without the necessity of wrestling a ramp or ladder around and accessing the backseat for storage during travel or hooking over the rear of the vehicle for loading and risking the attendant instability during loading or unloading of the pet.

The invention may be embodied in other forms without departure from the spirit and essential characteristics thereof. The embodiments described therefore are to be considered in all respects as illustrative and not restrictive. Although the present invention has been described in terms of certain preferred embodiments, other embodiments that are apparent to those of ordinary skill in the art are also within the scope of the invention. Accordingly, the scope of the invention is intended to be defined only by reference to the appended claims.

I claim:

1. Collapsible and retractable pet cage and stairway apparatus to be carried in the back bay of a vehicle and comprising:
a horizontal bottom frame having inboard and outboard sides and forward and rearward end walls, the bottom frame formed with an upwardly facing floor and a rearwardly opening tunnel;
a collapsible ladder device received slidably in the tunnel and including a plurality of ladder sections;
ladder slider devices interposed between the respective ladder sections for longitudinal sliding of the ladder sections, relative to one another;
a ladder mounting slider device received in the tunnel and receiving the ladder device for longitudinal sliding relative to the horizontal frame for deployment rearwardly of the ladder device;
a rigid front fence panel disposed at the front end of the horizontal bottom frame;
a rigid side fence disposed at the doored side of the horizontal frame;
front fence pivot devices mounted to the front end of the horizontal bottom frame and mounting the front fence panel for pivoting between an erect containment position and a collapsed lowered position disposed on the floor;
side panel pivot devices mounted on the inboard side of the horizontal bottom frame and mounting the side fence panel for pivoting between an erect position and a folded position, lowered to be disposed over the floor whereby the collapsible ladder device may be collapsed into the tunnel and the front end side fence panels pivoted about the respective pivot devices and lowered onto the floor for convenient transport of the apparatus to the back bay of the vehicle and loading into the back bay for subsequent pivoting of the front fence panel and side fence panel about the respective front pivot devices and side pivot devices to their respective front panel erect position and side panel erect position and deployment of the ladder device from the tunnel to a loading position for entry of a pet from the ladder device to the floor to be constrained by the prong and side panels to the floor.

2. The apparatus of claim 1 wherein:
the ladder device includes steps formed to, when the ladder device is in the loading position, be disposed in respective horizontal planes.

3. The apparatus of claim 1 wherein:
the front and side panels include respective front and side panel lower sections projecting when the front and side panels are the respective erect positions below the respective front and side panel pivot devices to form stops limiting pivoting in one direction of the respective front and side panels.

4. The apparatus of claim 1 wherein:
the front panel in includes rigid wires forming a woven fence having longitudinal wire runs; and
the front pivot devices include clips capturing the respective runs for rotation of the front panel about the respective clips.

5. The apparatus of claim 1 wherein:
the side panel includes a woven fence having horizontal wire runs; and
the side panel pivot devices include clips capturing the respective runs.

6. The apparatus of claim 1 wherein:
the front and side panels include rigid woven wire.

7. A pet cage for the back bay of a vehicle and comprising:
a horizontal frame to be received in the bay, the frame including an upwardly facing floor and at least two planer outwardly facing vertical walls;
a pair of rigid fence panels having respective joinder sections and rotatable from respective lowered positions on the floor to erect positions with the respective joinder sections juxtaposed, the respective panels including lower panel sections to, when the fence panels are in the erect positions abut the respective outwardly facing vertical walls;
clips mounted to the respective planer walls and pivotally engaging the respective fence panels to hold them in position;
knuckle fittings mounted to the respective joinder sections and formed with vertical bores aligned with one another when the respective panels are in the respective erect positions; and
bolts for removable receipt in the respective bores.

8. The cage apparatus of claim 7, wherein:
the fence is a woven wire fence.

9. The pet cage of claim 7, wherein:
the fence panels are constructed to be pivoted about the respective clips to be lowered downwardly to be disposed in respective horizontal planes on the top of the floor.

10. Pet cage and stairway apparatus comprising;
a pet cage including a horizontal frame having an upwardly facing floor and two containment sides;
rigid fence panels along the respective containment sides;
clips mounted to the horizontal frame on the containment sided and mounting the respective fence panels for rotation between erect containing positions and horizontal lowered positions overlying the floor;
the horizontal frame formed with a tunnel;
a ladder device received telescopically in the tunnel and deployable therefrom to a deployed position and including a plurality of steps to be disposed when the stairway is deployed position in respective horizontal planes.

11. A pet cage and stairway apparatus for mounting in the back bay of the vehicle and comprising:
a horizontal frame having orthogonal sides, configured with respective planer surfaces;
rigid fence panels disposed along the orthogonal sides for rotation between lowered positions and erect positions and including respective lower sections to, when the fence panels are in the erect position abut the respective planer surfaces;
the frame formed with an outwardly opening tunnel;
a stairway device constructed to be received in the tunnel and deployable therefrom to an extended position, the stairway device including first and second sections extendable longitudinally from one another to an extended position, the first section including longitudinal channels on the opposite and the second section including followers received in the respective channels for sliding there along for a selective extension retraction of ladder device.

12. The apparatus that were claim 11 wherein:
the channels are formed with vertically opening tracks; and
the followers are received into respective tracks.

13. The apparatus of claim 12 wherein:
the respective tracks are formed with the channels opening downwardly; and
the followers are constructed to project upwardly into the channels and provide support as the channels are drawn longitudinally along.

14. Collapsible pet cage and stairway apparatus to be carried in the back bay of a vehicle and comprising:
a horizontal bottom frame having an upwardly facing floor, inboard and outboard sides and forward and rearward ends;
the bottom frame formed with a rearwardly opening tunnel;
a collapsible ladder device received slidably in the tunnel and including a plurality of ladder sections;
ladder slider devices interposed between the respective ladder sections for longitudinal sliding of the ladder sections, relative to one another;
a ladder mounting slider device received in the tunnel and receiving the ladder device for longitudinal sliding relative to the horizontal frame for deployment rearwardly of the tunnel;
a rigid front fence panel at the front end of the horizontal bottom frame;
a rigid side fence disposed at the inboard side of the horizontal frame;
fence pivot devices at the front end of the horizontal bottom frame and mounting the front fence panel for pivoting between an erect containment position and a collapsed lowered position disposed on the floor;
side panel pivot devices on the inboard side of the horizontal bottom frame and mounting the side fence panel for pivoting between an erect position and a folded position lowered to be disposed over the floor whereby the collapsible ladder device may be collapsed into the tunnel and the front and the side fence panels pivoted about the respective pivot devices and lowered onto the floor for convenient transport of the apparatus to the back bay of the vehicle and loading thereinto and for subsequent pivoting of the front fence panel and side fence panel about the respective from front pivot devices and side pivot devices to their respective front panel erect position and side panel erect positions and deployment of the ladder device from the tunnel for entry of a pet from the ladder device to the floor to be contained on the floor.
